(19) United States
(12) Patent Application Publication
(10) Pub. No.: US 2021/0204303 A1
(43) Pub. Date: Jul. 1, 2021

(54) TRANSMIT POWER ALLOCATION AND MODULATION CODING SCHEME FOR MULTI-USER ORTHOGONAL FREQUENCY-DIVISION MULTIPLE ACCESS

(71) Applicants: Vinod Kristem, San Jose, CA (US); Arjun Anand, Santa Clara, CA (US); Alexander W. Min, Portland, OR (US); Rath Vannithamby, Portland, OR (US); Shahrnaz Azizi, Cupertino, CA (US)

(72) Inventors: Vinod Kristem, San Jose, CA (US); Arjun Anand, Santa Clara, CA (US); Alexander W. Min, Portland, OR (US); Rath Vannithamby, Portland, OR (US); Shahrnaz Azizi, Cupertino, CA (US)

(21) Appl. No.: 16/727,335

(22) Filed: Dec. 26, 2019

(51) Int. Cl. H04W 72/12; H04B 7/06; H04L 5/00; H04W 52/24; H04W 52/26; H04W 52/28; H04W 52/34; H04W 52/42; H04W 52/50

(52) U.S. Cl. CPC H04W 72/121; H04B 7/0617; H04B 7/0619; H04L 5/0007; H04L 5/0037; H04L 5/0044; H04W 84/12; H04W 52/262; H04W 52/286; H04W 52/346; H04W 52/42; H04W 52/50; H04W 52/241

(57) ABSTRACT

Embodiments of the present disclosure provide for determination of transmit power allocations and modulation and coding schemes for multiuser orthogonal frequency division multiple access downlink transmissions. Other embodiments may be described and claimed.

### FIELD

Embodiments of the present invention relate generally to the technical field of wireless communications.

### BACKGROUND

[2] The Institute of Electrical and Electronics Engineers (IEEE) is developing specifications for enhancements to high efficiency (HE) wireless local area networks (WLAN). See, for example, IEEE 802.11ax D4.0, February 2019—IEEE Draft Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications Amendment Enhancements for High Efficiency WLAN (hereinafter “IEEE 802.11ax”). Multi-user orthogonal frequency-division multiple access (MU-OFDMA) is a feature of IEEE 802.11ax that enables transmission to multiple users by multiplexing them in a frequency domain. Typical implementations address practical challenges by precomputing groups and storing them in memory before an access point (AP) even wins a transmission opportunity. This may inhibit flexible and appropriate deployment of spectrum resources.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a network in accordance with some embodiments.

FIG. 2 illustrates a transmission diagram in accordance with some embodiments.

FIG. 3 illustrates a multiuser high-efficiency protocol packet data unit in accordance with some embodiments.

FIG. 4 illustrates packet error rate versus signal-to-noise ratio curves in accordance with some embodiments.

FIG. 5 illustrates a chart that plots a cumulative distribution function of a percentage gain in sum goodput in accordance with some embodiments.

FIG. 6 illustrates signal processing circuitry of an access point in accordance with some embodiments.

FIG. 7 illustrates an operation flow/algorithmic structure in accordance with some embodiments.

FIG. 8 illustrates an operation flow/algorithmic structure in accordance with some embodiments.

FIG. 9 illustrates an operation flow/algorithmic structure in accordance with some embodiments.

FIG. 10 illustrates an example access point in accordance with various embodiments.

FIG. 11 is a block diagram illustrating components, according to some example embodiments, able to read instructions from a machine-readable or computer-readable medium (for example, a non-transitory machine-readable storage medium) and perform any one or more of the methodologies discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details.

In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

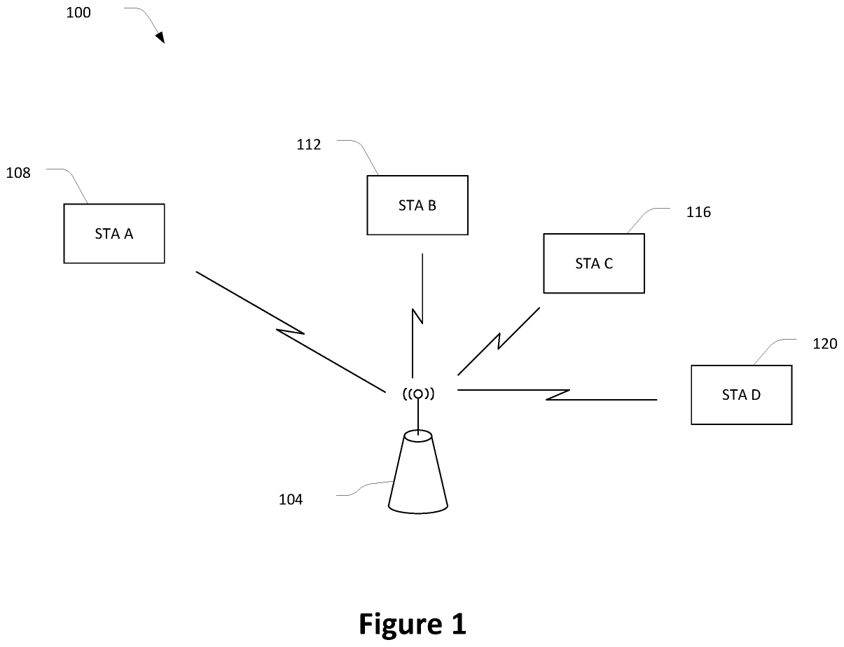

FIG. 1 illustrates a network 100 in accordance with some embodiments. The network 100 may include an AP 104 communicatively coupled with a plurality of stations (STAs) including, for example, STA A 108, STA B 112, STA C 116, and STA D 120. The network 100 may be a wireless local area network (WLAN) that is compatible with IEEE 802.11 protocols. In some embodiments, the network 100 may also be referred to as a basic service set (BSS). In some embodiments, the AP 104 and STAs may communicate based on high-efficiency wireless (HEW) protocols defined in, for example, IEEE 802.11ax. STAs operating based on high-efficiency (HEW) protocols may also be referred to as HEW or high-efficiency (HE) STAs.

In some embodiments, the AP 104 may generate transmissions to the plurality of the STAs of the network by multiplexing the transmissions in a frequency domain. The AP 104 may include the transmissions to multiple users in a MU high-efficiency—PHY protocol data unit (HE-PPDU) downlink transmission. As will be described in further detail, the AP 104 may tailor, on a station-by-station (or user-by-user) basis, the transmit power allocations or multi-user (MU)—modulation and coding schemes (MCS) of the MU HE-PPDU downlink transmission to improve various transmission metrics.

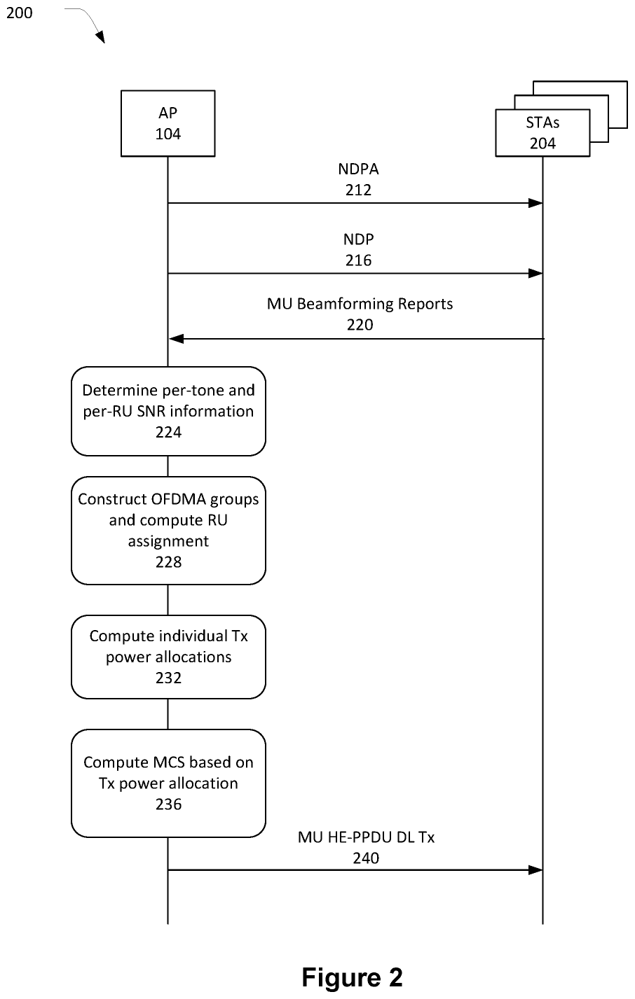

FIG. 2 illustrates a transmission diagram 200 in accordance with some embodiments. The transmission diagram 200 may describe messages and operations performed by AP 104 and stations 204. The stations 204 may include stations similar to, and substantially interchangeable with, the STAs of FIG. 1.

In some embodiments, the AP 104 may initiate a sounding process to facilitate construction of MU OFDMA groups and beamforming. This may be accomplished by the AP 104 periodically transmitting a null data packet announcement (NDPA) 212 and, subsequently, a null data packet (NDP) to the stations 204. The stations 204 may measure the NDP and generate feedback information, which is transmitted to the AP 104 in MU beamforming reports 220. In various embodiments, the feedback information may include an indication of beamforming vectors and signal-to-noise ratios (SNRs) for different subcarriers. Subcarriers may also be referred to as “tones.”

The AP 104 may collect the feedback information to determine the per-tone and per-resource unit (RU) SNR information at 224. In some embodiments, the per-tone SNR information may be (or may be based on) the SNR information fed back in the MU beamforming reports 220. The AP 104 may map the per-tone SNR information to a single SNR entry per RU, which may include a group of frequency-adjacent subcarriers. This mapping may be done by a simple linear averaging of the SNR across the tones of the RU or by using an effective SNR (ESNR) technique.

At 228, the AP 104 may construct MU OFDMA groups based on the per-RU SNR information. The AP 104 may also compute resource unit assignments by assigning users/STAs to different RUs.

In a previous implementations, a scheduler of an AP may use pre-computed and stored packet error rates (PER) vs. SNR curves to map the per-RU SNR to an MU-MCS. This information would then be used to determine the RU assignment and group combination. The precomputed group, RU assignment, and MU-MCSs would then be saved and subsequently used for real-time MU-HE-PPDU transmissions. However, the MU-MCS assignment would only be throughput optimal if the transmit power was equally divided among the stations of the group, since the NDP is received by the stations with the same AP transmit power.

In contrast to previous implementations, embodiments of the present disclosure provide, at 232, the AP 104 computing individual transmit power allocations for the stations to which an MU HE-PPDU transmission is to be sent in a manner to increase a transmission metric (for example, sum throughput/goodput) of the stations. In some embodiments, this may result in unequal transmit power allocations for stations within an MU OFDMA group, yet the overall transmit power may still be within a total transmit power constraint of the AP 104.

The transmission diagram 200 may further include, at 236, the AP 104 computing an MCS based on the computed transmit power allocations. The unequal transmit power allocations, computed at 232, may result in MCS assignments that differ from MU-MCS determined from processing the NDP. However, it may be noted that the MU-MCS determined from processing the NDP may still be used to determine the RU assignment and group combination.

In some embodiments, the computation of the individual transmit power allocations at 232 or the MCS at 236 may be additionally/alternatively be based on instantaneous buffer sizes corresponding to the stations. This may provide the AP 104 with the flexibility of selectively improving throughput for the stations having the most amount of data in the queue. This may also provide other spectral efficiencies as will be discussed in further detail.

At 240, the AP 104 may construct and transmit a MU HE-PPDU downlink transmission to the stations of an OFDMA group with the individually computed transmit power allocations and MCSs. In this manner, the AP 104 may tailor the downlink transmission in a desired manner. This approach may increase a transmission metric (for example, overall sum downlink throughput or goodput) or reduce airtime required by the AP 104 and, therefore, increase the network throughput. Furthermore, the orthogonality of the downlink transmissions among the users may be preserved regardless of a variation of the per-RU power allocations. Thus, unlike uplink power control, there may be no additional inter-user-interference penalty for any inaccuracy.

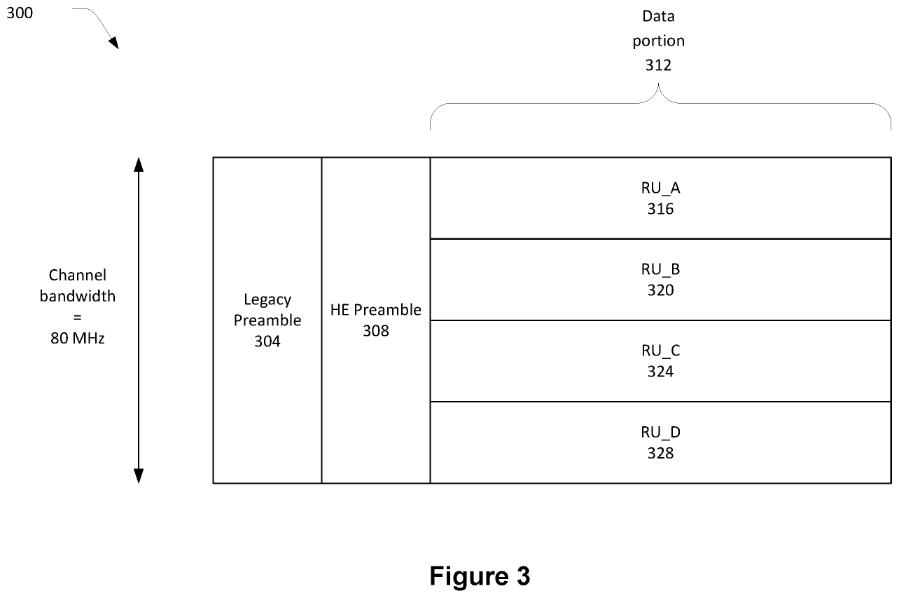

FIG. 3 illustrates an MU HE-PPDU 300 that may be constructed by the AP 104 and transmitted in a downlink transmission as described in, for example, FIG. 2.

The MU HE-PPDU 300 may include a legacy preamble 304 and a HE preamble 308 that span a channel bandwidth. As shown, the channel bandwidth may be 80 megahertz (MHz); however, this may be different in different embodiments.

The legacy preamble 304 may include legacy—short training field (L-STF), legacy—long training field (L-LTF), and legacy—signal field (L-SIG) that may be used for backward compatibility.

The L-SIG field may include information to allow a receiving station to determine a transmission time of the MU HE-PPDU 300. In some embodiments, the L-SIG field may have a length that indicates that the packet is a HE packet with a MU preamble.

The HE preamble 308 may include HE signal—A field (HE-SIG-A), HE signal-B field (HE-SIG-B), and one or more training fields, for example, HE-STF or HE-LTF.

The HE-SIG-A field may include common transmission parameters for the users having data within the data portion 312 of the MU HE-PPDU 300. The HE-SIG-B field may include RU allocation information and per-user signaling parameters for the users having data within the data portion 314.

The data portion 312 may include RUs assigned to stations of the OFDMA group. In this embodiment, the OFDMA group determined by the AP 104 may include the stations of FIG. 1 with each station being assigned a respective 20 MHz RU. For example, STA A 108 may be assigned RU_A 316, STA B 112 may be assigned RU_B 320, STA C 116 may be assigned RU_C 324, and STA D 120 may be assigned RU_D 328.

With the OFDMA group, RU size/assignments, and channel bandwidth of FIG. 3 serving as a basis, the computation of the individual transmit power allocations at 232 and the MCSs at 236 may be performed according to the following example.

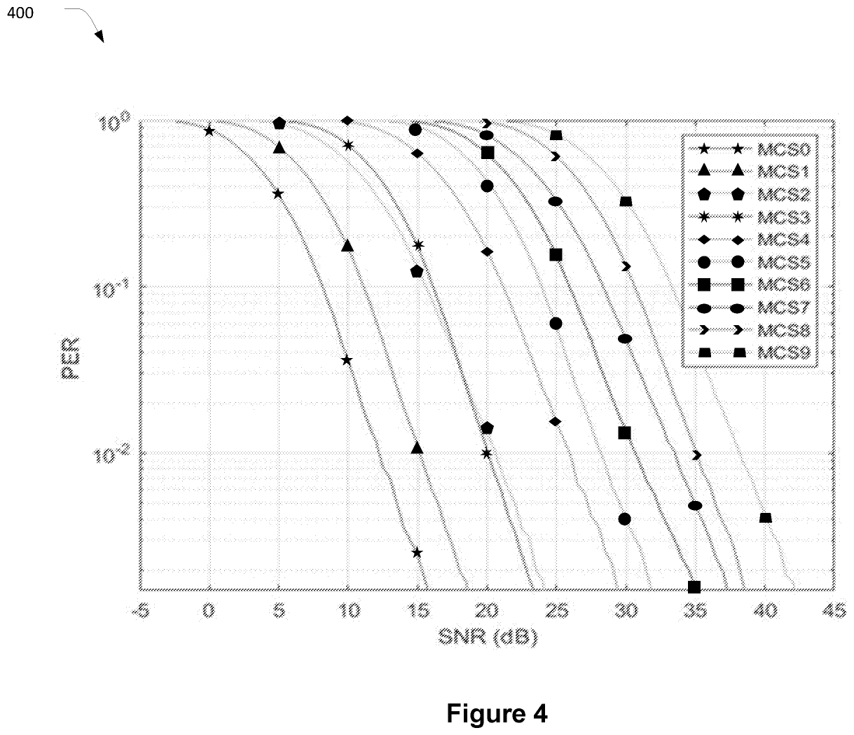

The AP 104 may operate with a total transmit power of P. From the MU beamforming reports 220, the AP 104 may determine the SNR per 20 MHz RU for STAs A, B, C, and D to be 10 dB, 20 dB, 31 dB and 15 dB, respectively. The AP 104 may access a PER vs. SNR curves 400 for different MCSs in an IEEE channel D model as shown in FIG. 4 in accordance with some embodiments.

The MCSs shown in FIG. 4 include MCSs 0-9. MCS 0 may include a binary phase shift keying (BPSK) modulation and 1/2 coding rate; MCS 1 may include a quadrature phase shift keying (QPSK) modulation and 1/2 coding rate; MCS 2 may include a QPSK modulation and a 3/4 coding rate; MCS 3 may include a 16-quadrature amplitude modulation (QAM) modulation and a 1/2 coding rate; MCS 4 may include a 16-QAM modulation and a 3/4 coding rate; MCS 5 may include a 64-QAM and a 2/3 coding rate; MCS 6 may include a 64-QAM modulation and a 3/4 coding rate; MCS 7 may include a 64-QAM modulation and a 5/6 coding rate; MCS 8 may include a 256-QAM and a 3/4 coding rate; and MCS 9 may include a 256-QAM and a 5/6 coding rate. Other embodiments may include other combinations of modulations and coding rates. For example, some embodiments may include MCS index 10 with a 1024-QAM modulation and a 3/4 coding rate; and MCS index 11 with a 1024-QAM modulation and a 5/6 coding rate.

From the PER vs SNR curves 400, the maximum MCS supported by STAs A, B, C, and D in order to maintain a target PER of less than 0.1, for example, comes out to be 0, 3, 8, and 1 respectively. A previous implementation would then use the MU-MCS of (0, 3, 8, 1) for a real-time 80 MHz MU HE-PPDU downlink transmission with group (A, B, C, D), with a transmit power of P/4 for each STA. However, if we increase the transmit power of RU_A 316 by 3 dB and decrease the transmit power of RU_B and RU_D by 3 dB, the power allocation across the STAs would be (P/2, P/8, P/4, P/8), with the total transmit power still being P. For this power allocation, the SNR per RU for STAs A, B, C, and D would be 13 dB, 17 dB, 31 dB and 12 dB, respectively, and the maximum MU-MCS for the group (A, B, C, D) would be (1, 3, 8, 1). Thus, using unequal transmit power allocation for the STAs, while keeping the total transmit power the same, improves the sum throughput of the OFDMA group (A, B, C, D).

In some embodiments, the AP 104 use a transmit power allocation of (P1, P2, P3, P4) such that P1+P2+P3+P4=P. The MCS with this power allocation can be different from the MU-MCS determined based solely on the per-RU SNR, (0, 3, 8, 1) as shown in the example above. In some embodiments, the desired choice of (P1, P2, P3, P4) will be the one that increases (or maximizes in some embodiments) a sum goodput of the OFMDA group (A, B, C, D). As used herein, the goodput metric may be computed as (1−PER)*PHY throughput, wherein PHY throughput is an estimated throughput at a physical layer of a receiving station.

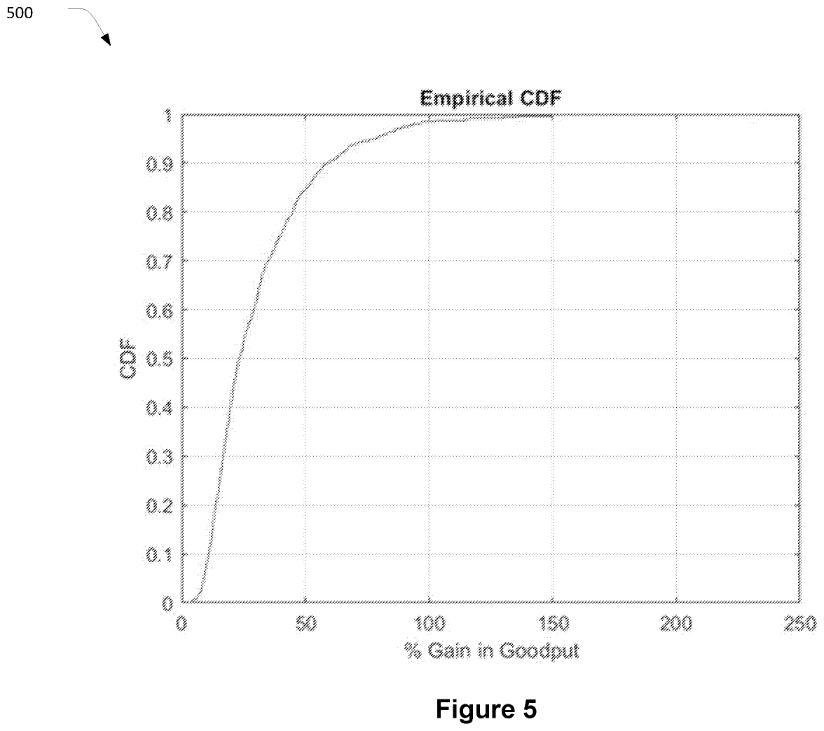

FIG. 5 is a chart 500 that plots a cumulative distribution function (CDF) of a percentage gain in sum goodput in accordance with some embodiments. The CDF may be obtained by individualizing the transmit power allocation across the STAs in an OFDMA group. In particular, the empirical CDF may be obtained over several random drops of STAs and random generation of groups in IEEE channel D model with 20 MHz RU size and 80 MHz channel bandwidth. The gains are computed relative to equal power allocation among the STAs in the group. It can be seen that, on average the sum goodput may be increased by 25% and in 10% of scenarios, gains in sum goodput can be more than 60% in accordance with some embodiments.

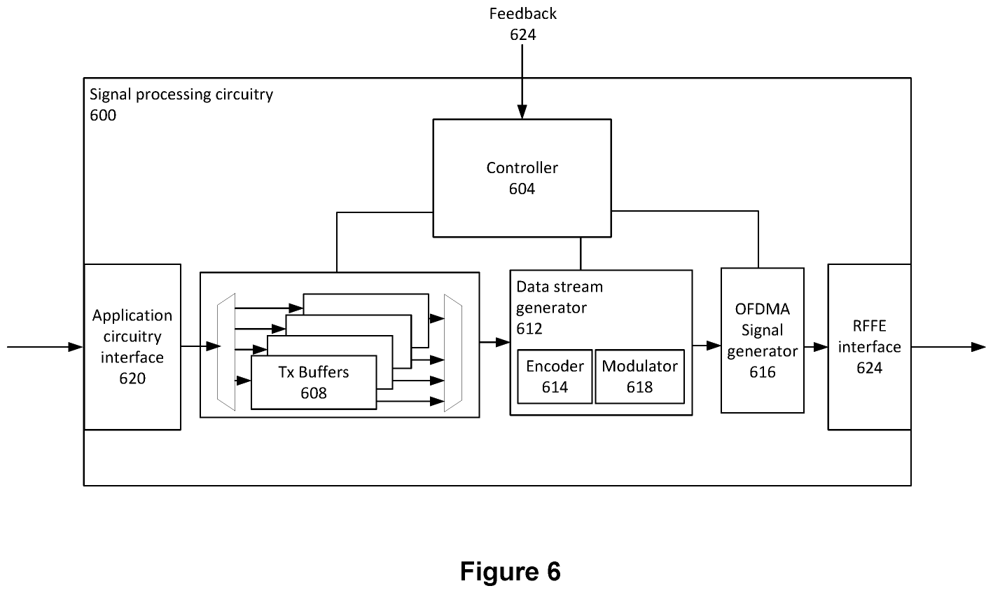

FIG. 6 illustrates signal processing circuitry 600 in accordance with some embodiments. The signal processing circuitry 600 may be included in the AP 104 in accordance with some embodiments.

As used herein, the term “circuitry” may refer to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. In addition, the term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The signal processing circuitry 600 may include a controller 604 that includes processor/memory circuitry to execute elements of a protocol stack including, for example, physical (PHY) and media access control (MAC) layer functionality. In some embodiments, the controller 604, which may also be referred to as a “scheduler,” may be coupled with transmission buffers 608, a data stream generator 612, and an OFDMA signal generator 616.

The signal processing circuitry 600 may include an application circuitry interface 620 that provides the transmission buffers 608 with application layer data going to various stations within a WLAN. The transmission buffers 608 may provide selected application layer data to the data stream generator 612.

The data stream generator 612 may include a number of transmit operation blocks that, under the control of controller 604, are to process the selected application layer data into a plurality of data streams that are provided to the OFDMA signal generator 616. The transmit operation blocks of the data stream generator 612 may include, but are not limited to, an encoder 614 and a modulator 618.

The OFDMA signal generator 616 may receive the data streams from the data stream generator 612 and generate an OFDMA signal that is provided to a radio frequency front end (RFFE) interface 624. The operation blocks of the OFDMA signal generator 616 may include, but are not limited to, a space-time block coding (STBC) block and a digital beamforming (DBF) block.

In general, the OFDMA signal generator 616 may generate orthogonal frequency division multiplexing (OFDM) symbols based on the modulated data streams and map the OFDM onto a plurality of orthogonal subcarriers so that the OFDM symbols are encoded with the subcarriers or tones.

The STBC block, when included, may receive constellation points from a modulator of the data stream generator 612 corresponding to the spatial streams and spread the spatial streams to a greater number of space-time streams.

The DBF block, when included, may employ digital signal processing algorithms to process a channel state and computed steering matrix that is applied to transmitted signal to improve reception at a particular receiver. This may be achieved by combining elements in a phased antenna array in a manner to exploit constructive and destructive signal interference experienced by the receivers.

The controller 604 may dynamically control the components of the signal processing circuitry 600 based on feedback 624. The feedback 624 may include information (for example, SNR information) collected from MU beamforming reports. The controller 604 may construct OFDMA groups, determine per-RU SNR information; and compute RU assignments, individual transmit power allocations, and MCSs as described above with respect to FIG. 2, for example. The controller 604 may control the transmission buffers 608 to provide data for stations in a constructed OFDMA group to the data stream generator 612. The controller 604 may control the encoder 614 and the modulator 618 based on the computed MCS assignments, to generate the one or more data streams that include the selected data and provide the streams to the OFDMA signal generator 616. The OFDMA signal generator 616 may then construct an MU HE-PPDU, such as MU HE-PPDU 300, to be transmitted in downlink transmission with the transmit power allocations as indicated by the controller 604.

In some embodiments, the controller 600 may further control the components of the signal processing circuitry 600 to provide a transmit power allocation and MU-MCS assignment for stations in the OFDMA group based on a number of packets buffered in the transmission buffers 608. This may be especially useful in situations that include heterogeneous traffic rates to various stations, resulting in a significant variance in the number of packets queued for each station.

For the stations with a relatively large number of packets buffered, the controller 604 may increase the transmit power allocation and step up the MU-MCS in order to include more bits per transmitted packet. For the stations with a relatively small number of packets buffered, the controller 604 may decrease the transmit power allocation and step down the MU-MCS. Adjusting the transmit power allocation in the MCS in this manner may align transmissions from different stations with one another. This may, in turn, reduce or eliminate the need for zero padding of the packet and improve the packing efficiency. The airtime required for the AP 104 to do the downlink transmissions may also be reduced, which may result in improved network spectral efficiencies.

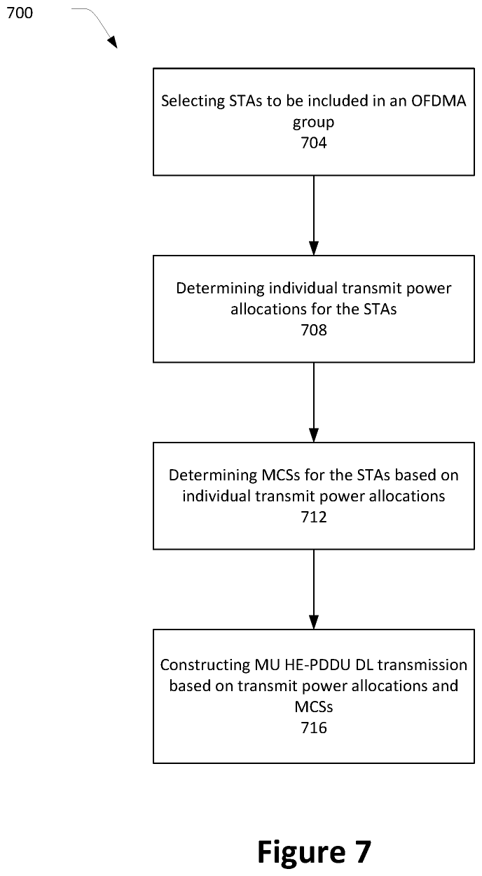

FIG. 7 illustrates an operation flow/algorithmic structure 700 in accordance with some embodiments. The operation flow/algorithmic structure 700 may be implemented by an access point, for example, access point 104, or components thereof, for example, signal processing circuitry 600.

At 704, the operation flow/algorithmic structure 700 may include selecting stations to be included in an OFDMA group. In some embodiments, the selecting of the stations may be based on feedback information included in, for example, MU beamforming reports 220. For example, the access point 104 may compute a per-RU SNR based on per-tone SNRs received in the reports. The per-RU SNR may then serve as a basis for the selection of the stations to be included in the OFDMA group and the RUs assigned to the particular stations.

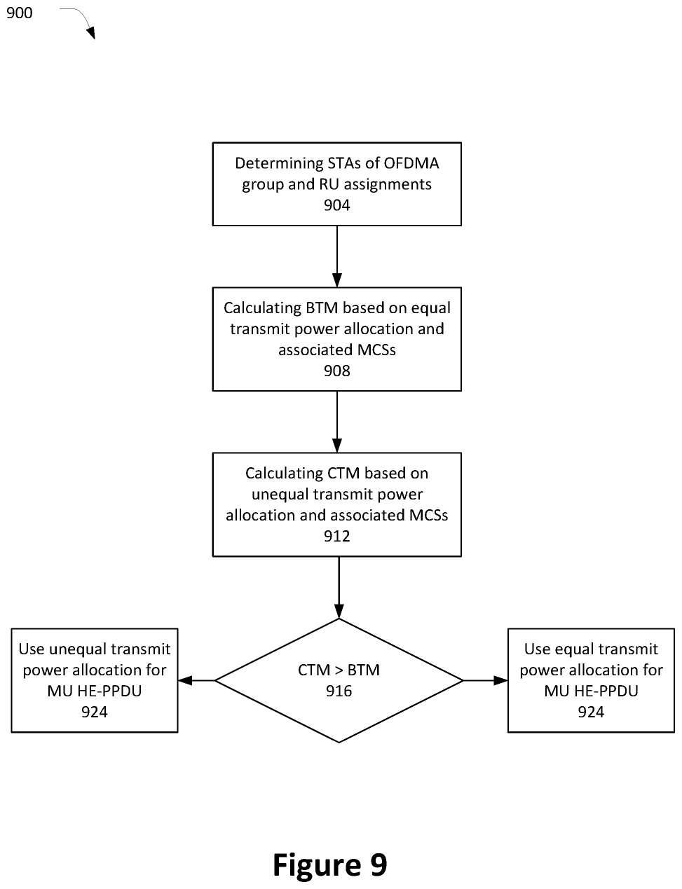

At 708, the operation flow/algorithmic structure 700 may further include determining individual transmit power allocations for the stations included in the OFDMA group. In some embodiments, the individual transmit power allocations may be determined in a manner that increases an overall transmission metric (for example, throughput or goodput) associated with the transmission. In some embodiments, such as that described with respect to FIG. 9, a baseline transmission metric may be determined based on an equal power allocation and one or more unequal power allocations may be compared to the baseline transmission metric. The AP 104 may select one of the unequal power allocations for use if it improves the transmission metric over the baseline.

In various embodiments, transmissions directed to certain stations may be provided a relatively higher transmit power allocation as compared to other stations in the OFDMA group. For example, a transmission to a first station on a first RU may be provided a relatively higher transmit power allocation if the first RU is associated with a SNR that is less than SNRs of other RUs used for transmissions to other stations in the OFDMA group. In another example, a transmission to first station may be provided a relatively higher transmit power allocation if the transmission buffer for the first station includes a higher number of packets to be transmitted. If a transmit power allocation is increased for one or more stations, the transmit power allocations may be decreased for one or more other stations in the OFDMA group in order to not exceed a total transmit power allocated to the access point 104.

At 712, the operation flow/algorithmic structure 700 may further include selecting MCSs for the stations included in the OFDMA group. The MCSs may be based on the unequal transmit power allocation determined at 708 and may be further based on PER vs. SNR curves, for example, PER vs SNR curves 400, which may be stored in a memory of the access point 104. The MCS assignment determined at 712 may be different from an MCS that would be computed directly from the feedback information in the MU beamforming reports 220.

At 716, the operation flow/algorithmic structure 700 may further include constructing an MU HE-PPDU based on the transmit power allocations and MCSs determined at 708 and 712. The constructed MU HE-PPDU, which may be similar to MU HE-PPDU 300, may be transmitted in a downlink transmission by the access point 104 with the individual transmit power allocations determined at 708.

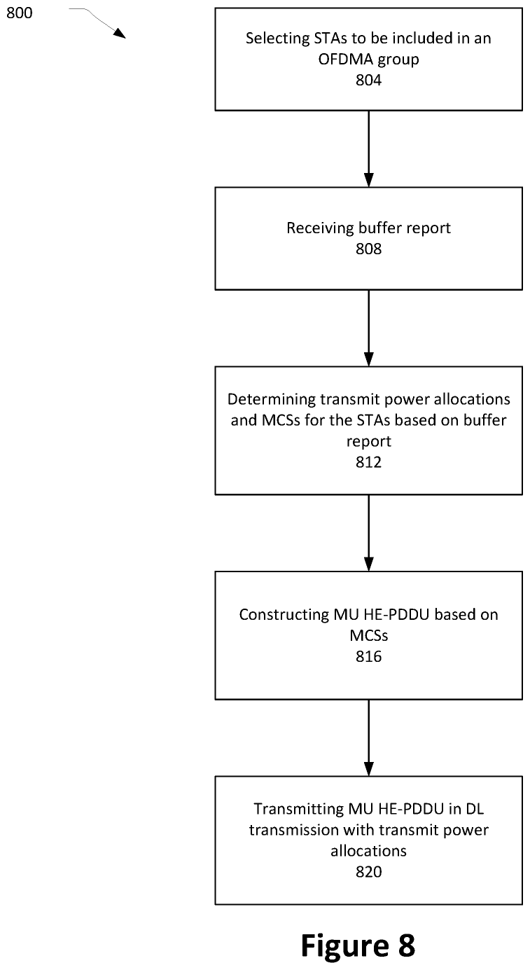

FIG. 8 illustrates an operation flow/algorithmic structure 800 in accordance with some embodiments. The operation flow/algorithmic structure 800 may be implemented by an access point, for example, access point 104, or components thereof, for example, signal processing circuitry 600.

At 804, the operation flow/algorithmic structure 800 may include selecting stations to be included in an OFDMA group. The selection of the stations at 804 may be similar to the selection described above at 704.

At 808, the operation flow/algorithmic structure 800 may further include receiving a buffer report. In some embodiments, a controller, for example, controller 604, may receive a buffer report from transmission buffers, for example, transmission buffers 608. The reports may be received periodically or in real time. The reports may provide an indication of an amount of data to be transmitted to one or more stations in a WLAN. In some embodiments, the amount of data may correspond to a number of packets or bits to be transmitted.

At 812, the operation flow/algorithmic structure 800 may further include determining transmit power allocations and MCSs for the stations based on the buffer report. In some embodiments, a total transmit power allocation for an AP may be equally divided among the stations of the OFDMA group. From this baseline allocation, transmit power allocations corresponding to station having associated transmission buffers with relatively more data may be increased. To remain within the constraint of the total transmit power allocation, transmit power allocations corresponding to stations having associated transmission buffers with relatively less data may be decreased. Thus, in this manner, the total transmit power allocation budget may be redistributed based on the statuses of the transmission buffers. Upon redistributing the total transmit power allocation budget, the individual MCSs may be determined based on the individual transmit power allocations.

At 816, the operation flow/algorithmic structure 800 may further include constructing an MU HE-PPDU based on the individual MCSs. The MU HE-PPDU may be constructed similar to that described above with respect to FIG. 6.

At 820, the operation flow/algorithmic structure 800 may further include transmitting the MU HE-PPDU in a downlink transmission with the individual transmit power allocations.

FIG. 9 illustrates an operation flow/algorithmic structure 900 in accordance with some embodiments. The operation flow/algorithmic structure 900 may be implemented by an access point, for example, access point 104, or components thereof, for example, signal processing circuitry 600.

At 904, the operation flow/algorithmic structure 900 may include determining stations of an OFDMA group and corresponding RU assignments for a MU HE transmission. In some embodiments, the determination of the stations and RU assignments may be based on feedback information from MU beamforming reports as described herein.

At 908, the operation flow/algorithmic structure 900 may further include calculating a baseline transmission metric (BTM) based on an equal transmit power allocation and associated MCSs. For example, a sum goodput value may be calculated based on the equal transmit power allocations and MCSs as described herein.

At 912, the operation flow/algorithmic structure 900 may further include calculating a candidate transmission metric (CTM) based on unequal transmit power allocations and associated MCSs. For example, a sum goodput value may be calculated based on the unequal transmit power allocations and associated MCSs as described herein.

The unequal transmit power allocations may result from a first subset of the stations having their transmit power allocations increased, while a second subset of the stations have their transmit power allocations decreased. As described herein, whether the stations are to be included in the first or second subsets may be based on relative RU SNR values, transmission buffer levels, etc.

At 916, the operation flow/algorithmic structure 900 may further include comparing the candidate transmission metric to the baseline transmission metric.

If, at 916, the candidate transmission metric is greater than the baseline transmission metric then the operation flow/algorithmic structure 900 may include, at 920, using the unequal transmit power allocation for the MU HE-PPDU, with the MCSs used to construct the MU HE-PPDU being those associated with the unequal transmit power allocation.

If, at 916, the candidate transmission metric is less than the baseline transmission metric then the operation flow/algorithmic structure 900 may include, at 924, using the equal transmit power allocation for the MU HE-PPDU, with the MCSs used to construct the MU HE-PPDU being those associated with the equal transmit power allocation.

While the operation flow/algorithmic structure 900 describes calculating one candidate transmission metric and comparing it to one baseline transmission metric, other embodiments may include comparing a number of additional candidate transmission metrics. For example, a plurality of sum goodput values may be determined for a respective plurality of combinations of transmit power allocations and MCSs. Then a combination that is associated with a relatively maximum sum goodput value may be selected for construction and transmission of a MU HE-PPDU.

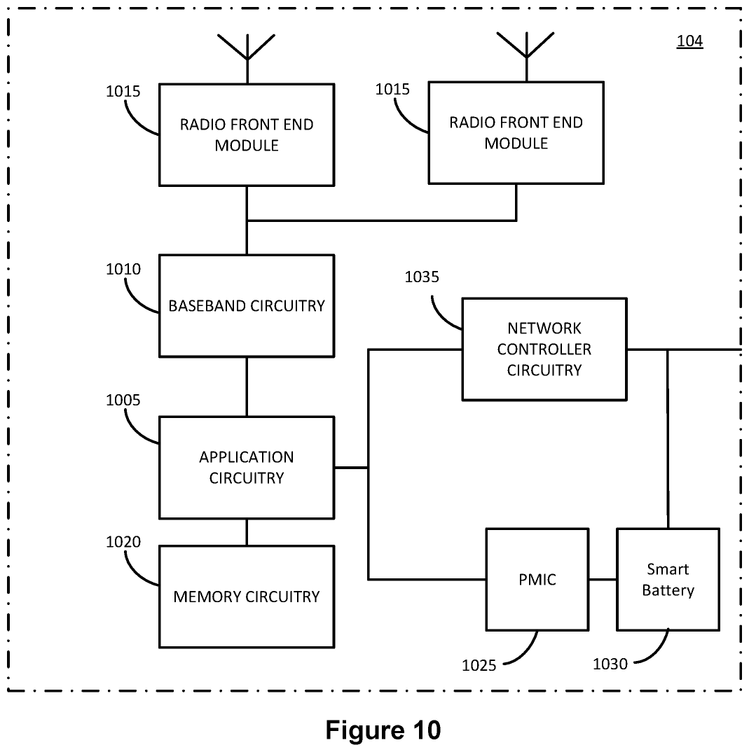

FIG. 10 illustrates an example of the AP 104 in accordance with various embodiments. The AP 104 may include one or more of application circuitry 1005, baseband circuitry 1010, one or more radio front end modules 1015, memory circuitry 1020, power management integrated circuitry (PMIC) 1025, and network controller circuitry 1035.

The terms “application circuitry” and/or “baseband circuitry” may be considered synonymous to, and may be referred to as, “processor circuitry.” As used herein, the term “processor circuitry” may refer to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Application circuitry 1005 may include one or more central processing unit (CPU) cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. As examples, the application circuitry 1005 may include one or more Intel Pentium®, Core®, or Xeon® processor(s); Advanced Micro Devices (AMD) Ryzen® processor(s), Accelerated Processing Units (APUs), or Epyc® processors; and/or the like. In some embodiments, the AP 104 may not utilize application circuitry 1005, and instead may include a special-purpose processor/controller to process IP data received from an EPC or 7GC, for example.

Additionally or alternatively, application circuitry 1005 may include circuitry such as, but not limited to, one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 1005 may comprise logic blocks or logic fabric, and other interconnected resources that may be programmed to perform various functions, such as the procedures, methods, functions, etc. of the various embodiments discussed herein. In such embodiments, the circuitry of application circuitry 1005 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 1010 may be implemented, for example, as a solder-down substrate including one or more integrated circuits, a single packaged integrated circuit soldered to a main circuit board or a multi-chip module containing two or more integrated circuits. Although not shown, baseband circuitry 1010 may comprise one or more digital baseband systems, which may be coupled via an interconnect subsystem to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include digital signal processing circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 1010 may include protocol processing circuitry (for example, signal processing circuitry 600) with one or more instances of control circuitry (not shown) to provide control functions for the digital baseband circuitry and/or radio frequency circuitry (e.g., the radio front end modules 1015).

The radio front end modules (RFEM) 1015 may include radio frequency integrated circuits (RFICs), amplifiers (for example, power amplifiers and low-noise amplifiers), and antenna elements to effectuate over-the-air transmissions. The RFEM 1015 may include beamforming circuitry to increase transmission/reception directivity.

The memory circuitry 1020 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 520 may be implemented as one or more of solder down packaged integrated circuits, socketed memory modules and plug-in memory cards.

The PMIC 1025 may include voltage regulators, surge protectors, power alarm detection circuitry, and one or more backup power sources such as a battery or capacitor. The power alarm detection circuitry may detect one or more of brown out (under-voltage) and surge (over-voltage) conditions.

The network controller circuitry 1035 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the access point 104 using a physical connection, which may be electrical (commonly referred to as a “copper interconnect”), optical, or wireless. The network controller circuitry 1035 may include one or more dedicated processors and/or FPGAs to communicate using one or more of the aforementioned protocols. In some implementations, the network controller circuitry 1035 may include multiple controllers to provide connectivity to other networks using the same or different protocols.

The components shown by FIG. 10 may communicate with one another using interface circuitry. As used herein, the term “interface circuitry” may refer to, is part of, or includes circuitry providing for the exchange of information between two or more components or devices. The term “interface circuitry” may refer to one or more hardware interfaces, for example, buses, input/output (I/O) interfaces, peripheral component interfaces, network interface cards, and/or the like. Any suitable bus technology may be used in various implementations, which may include any number of technologies, including industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in a SoC based system. Other bus systems may be included, such as an I2C interface, an SPI interface, point to point interfaces, and a power bus, among others.

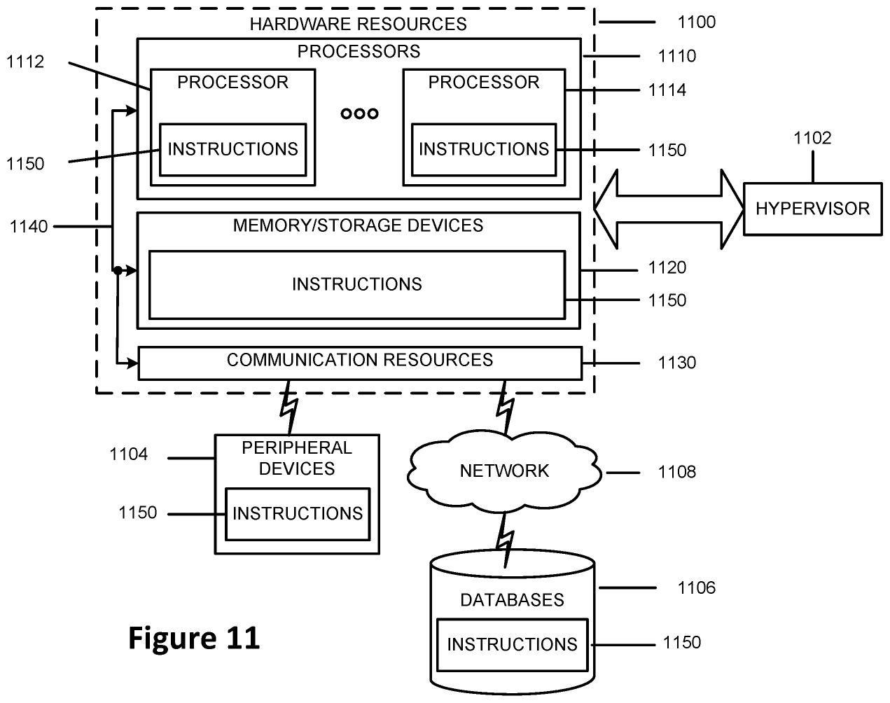

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140. As used herein, the term “computing resource”, “hardware resource”, etc., may refer to a physical or virtual device, a physical or virtual component within a computing environment, and/or physical or virtual component within a particular device, such as computer devices, mechanical devices, memory space, processor/CPU time and/or processor/CPU usage, processor and accelerator loads, hardware time or usage, electrical power, input/output operations, ports or network sockets, channel/link allocation, throughput, memory usage, storage, network, database and applications, and/or the like. For embodiments where node virtualization (e.g., NFV) is utilized, a hypervisor 1102 may be executed to provide an execution environment for one or more network slices/sub-slices to utilize the hardware resources 1100. A “virtualized resource” may refer to compute, storage, and/or network resources provided by virtualization infrastructure to an application, device, system, etc.

The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1114.

The memory/storage devices 1120 may include main memory, disk storage, or any suitable combination thereof. The memory/storage devices 1120 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1130 may include interconnection or network interface components or other suitable devices to communicate with one or more peripheral devices 1104 or one or more databases 1106 via a network 1108. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components. As used herein, the term “network resource” or “communication resource” may refer to computing resources that are accessible by computer devices via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

Instructions 1150 may comprise software, a program, an application, an applet, an app, or other executable code for causing at least any of the processors 1110 to perform any one or more of the methodologies discussed herein. For example, the instructions 1150 may cause one or more of the processors 1110 to determine individual transmit power allocations and MCSs for a multiuser OFDM a downlink transmission as described herein.

The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include a method of operating an access point, the method comprising: selecting a plurality of stations to be included in an orthogonal frequency division multiple access (OFDMA) group; determining individual transmit power allocations for the plurality of stations; selecting, based on the individual transmit power allocations, individual modulation and coding schemes (MCSs) for the plurality of stations; and constructing, based on the individual transmit power allocations and MCSs, a multi-user (MU) high-efficiency physical protocol data unit (HE-PPDU) to be transmitted to the plurality of stations.

Example 2 may include the method of example 1 or some other example herein, further comprising: transmitting null data packet transmissions; processing one or more reports received from the plurality of stations based on the null data packet transmissions; and selecting the plurality of stations to be included in the OFDMA group based on the one or more reports.

Example 3 may include the method of example 1 or some other example herein, wherein at least two of the individual transmit power allocations are unequal and a sum of the individual transmit power allocations for the plurality of stations is less than or equal to a total transmit power allocation for the access point.

Example 4 may include the method of example 1 or some other example herein, further comprising: determining a plurality of goodputs that respectively correspond to individual transmit power allocations and MCSs for the plurality of stations; and determining the individual transmit power allocations and MCSs for the plurality of stations based on a determination that a sum of the plurality of goodputs is a relative maximum sum goodput.

Example 5 may include the method of example 4 or some other example herein, further comprising: determining a sum goodput of a plurality of combinations of transmit power allocations and MCSs for the plurality of stations included in the OFDMA group; selecting a combination of the plurality of combinations that includes the relative maximum sum goodput; and determining the individual transmit powers and MCSs as those included in the combination.

Example 6 may include the method of example 4 or some other example herein, further comprising: determining a first goodput value of the plurality of goodput values based on (1−PER)*PHY throughput, wherein PER is a packet error rate corresponding to a first transmit power allocation and MCS and PHY throughput is a physical layer throughput corresponding to the first MCS.

Example 7 may include the method of example 1 or some other example herein, further comprising: determining a number of packets buffered for the individual stations of the plurality of stations; and determining the individual transmit powers for the plurality of stations based on the number of packets buffered for a corresponding station.

Example 8 may include the method of example 7 or some other example herein, further comprising: selecting the individual MCSs based on the number of packets buffered for a corresponding station.

Example 9 may include the method of example 1 or some other example herein, further comprising: calculating a baseline transmission metric based on an equal transmit power allocation among the plurality of stations; calculating a candidate transmission metric based on an unequal transmit power allocation among the plurality of stations, the unequal transmit power allocation to correspond to the selected individual transmit power allocations; and selecting the individual transmit power allocations based on a comparison of the baseline transmission metric to the candidate transmission metric.

Example 10 may include a method comprising: buffering, in a plurality of transmission buffers, data to be transmitted to a respective plurality of stations to be included in an orthogonal frequency division multiple access (OFDMA) group; receiving buffer reports from the plurality of transmission buffers; determining, based on the buffer reports, individual transmit power allocations for the plurality of stations; determining, based on the individual transmit power allocations, individual modulation and coding schemes (MCSs) for the plurality of stations; controlling components of signal processing circuitry to construct, based on the individual transmit power allocations and MCSs, a multi-user (MU) high-efficiency physical protocol data unit (HE-PPDU) to be transmitted to the plurality of stations.

Example 11 may include the method of example 10 or some other example herein, further comprising: generating a plurality of data streams based on the individual MCSs for the plurality of stations; and generating the MU HE-PPDU based on the data streams.

Example 12 may include the method of example 11 or some other example herein, further comprising: receiving feedback information from multi-user beamforming reports; and selecting the plurality of stations to be included in the OFDMA group based on the feedback information.

Example 13 may include the method of example 12 or some other example herein, further comprising: determining, based on the feedback information, signal-to-noise ratios (SNRs) for resource units; and determining the individual transmit power allocations based further on the SNRs.

Example 14 may include the method of example 11 or some other example herein, further comprising: determining a first transmission metric based on a total transmit power allocation of an access point being equal distributed among the plurality of stations included in the ODFMA group; determining a second transmission metric based on the total transmit power allocation being distributed among the plurality of stations with the individual transmit power allocations; and determining the individual transmit power allocations are to be used for the MU HE-PPDU based on a comparison of the first transmission metric to the second transmission metric.

Example 15 may include the method of example 14 or some other example herein, wherein the first transmission metric is a goodput metric or a throughput metric.

Example 16 may include a method of operating an access point, the method comprising: generating application data to be transmitted to a plurality of stations; selecting a subset of the plurality of stations; generating a multi-user (MU) high-efficiency physical protocol data unit (HE-PPDU) to include data to be transmitted to the subset, wherein, generating the MU HE-PPDU includes determining transmit power allocations for the subset of stations, wherein at least two of the transmit power allocations are unequal; and transmitting the MU HE-PPDU to the subset of stations.

Example 17 may include the method of example 16 or some other example herein, further comprising: receiving feedback information from multi-user beamforming reports; and selecting MCSs for the data to be transmitted to the subset of stations based on the transmit power allocations and the feedback information.

Example 18 may include the method of example 16 or some other example herein, further comprising beamforming a downlink transmission that includes the MU HE-PPDU.

Example 19 may include the method of example 16 or some other example herein, further comprising determining the transmit power allocations for the subset of stations based on an amount of data in transmission buffers respectively corresponding to the subset of stations.

Example 20 may include a method of operating an access point, the method comprising: calculating a baseline transmission metric based on an equal transmit power allocation among a plurality of stations of an orthogonal frequency division multiple access (OFDMA) group; calculating a candidate transmission metric based on an unequal transmit power allocation among the plurality of stations of the OFDMA group; selecting the unequal transmit power allocation based on a comparison of the baseline transmission metric to the candidate transmission metric; and constructing a multiuser high-efficiency protocol packet data unit (MU HE-PPDU) for transmission to the plurality of stations using the unequal transmit power allocation.

Example 21 may include the method of example 20 or some other example herein, further comprising: receiving feedback information in one or more multiuser beamforming reports; determining signal-to-noise ratios (SNRs) based on the feedback information; and mapping SNRs to first modulation and coding schemes (MCSs) for the plurality of stations.

Example 22 may include the method of example 21 or some other example herein, further comprising: calculating the baseline transmission metric based on the first MCSs; determining second MCSs for the plurality of station based on the unequal transmit power allocation; and calculating the candidate transmission metric based on the second MCSs.

Example 23 may include the method of example 20 or some other example herein, wherein the candidate transmission metric and the baseline transmission metric are throughput values.

Example 24 may include the method of example 20 or some other example herein, wherein the candidate transmission metric and the baseline transmission metric are goodput values, wherein a goodput value is based on (1−PER)*PHY throughput, wherein PER is a packet error rate corresponding to a first transmit power allocation and MCS and PHY throughput is a physical layer throughput corresponding to the first MCS.

Example 23 may include an apparatus comprising means to perform one or more elements of a method described in or related to any of examples 1-24, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 25 may include an apparatus comprising logic, modules, or circuitry to perform one or more elements of a method described in or related to any of examples 1-24, or any other method or process described herein.

Example 26 may include a method, technique, or process as described in or related to any of examples 1-24, or portions or parts thereof.

Example 27 may include an apparatus comprising: one or more processors and one or more computer readable media comprising instructions that, when executed by the one or more processors, cause the one or more processors to perform the method, techniques, or process as described in or related to any of examples 1-24, or portions thereof.

Example 28 may include a signal as described in or related to any of examples 1-24, or portions or parts thereof.

Example 29 may include a signal in a wireless network as shown and described herein.

Example 30 may include a method of communicating in a wireless network as shown and described herein.

Example 31 may include a system for providing wireless communication as shown and described herein.

Example 32 may include a device for providing wireless communication as shown and described herein.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. One or more non-transitory, computer-readable media having instructions that, when executed by one or more processors, cause an access point to:
select a plurality of stations to be included in an orthogonal frequency division multiple access (OFDMA) group;
determine individual transmit power allocations for the plurality of stations;
select, based on the individual transmit power allocations, individual modulation and coding schemes (MCSs) for the plurality of stations; and
construct, based on the individual transmit power allocations and MCSs, a multi-user (MU) high-efficiency physical protocol data unit (HE-PPDU) to be transmitted to the plurality of stations.

2. The one or more non-transitory, computer-readable media of claim 1, wherein the instructions, when executed, further cause the access point to:
transmit null data packet transmissions;
process one or more reports received from the plurality of stations based on the null data packet transmissions; and
select the plurality of stations to be included in the OFDMA group based on the one or more reports.

3. The one or more non-transitory, computer-readable media of claim 1, wherein at least two of the individual transmit power allocations are unequal and a sum of the individual transmit power allocations for the plurality of stations is less than or equal to a total transmit power allocation for the access point.

4. The one or more non-transitory, computer-readable media of claim 1, wherein the instructions, when executed, further cause the access point to:
determine a plurality of goodputs that respectively correspond to individual transmit power allocations and MCSs for the plurality of stations; and
determine the individual transmit power allocations and MCSs for the plurality of stations based on a determination that a sum of the plurality of goodputs is a relative maximum sum goodput.

5. The one or more non-transitory, computer-readable media of claim 4, wherein the instructions, when executed, further cause the access point to:
determine a sum goodput of a plurality of combinations of transmit power allocations and MCSs for the plurality of stations included in the OFDMA group;
select a combination of the plurality of combinations that includes the relative maximum sum goodput; and
determine the individual transmit powers and MCSs as those included in the combination.

6. The one or more non-transitory, computer-readable media of claim 4, wherein the instructions, when executed, further cause the access point to:
determine a first goodput value of the plurality of goodput values based on (1−PER)*PHY throughput, wherein PER is a packet error rate corresponding to a first transmit power allocation and MCS and PHY throughput is a physical layer throughput corresponding to the first MCS.

7. The one or more non-transitory, computer-readable media of claim 1, wherein the instructions, when executed, further cause the access point to:
determine a number of packets buffered for the individual stations of the plurality of stations; and
determine the individual transmit powers for the plurality of stations based on the number of packets buffered for a corresponding station.

8. The one or more non-transitory, computer-readable media of claim 7, wherein the instructions, when executed, further cause the access point to:
select the individual MCSs based on the number of packets buffered for a corresponding station.

9. The one or more non-transitory, computer-readable media of claim 1, wherein the instructions, when executed, further cause the access point to:
calculate a baseline transmission metric based on an equal transmit power allocation among the plurality of stations;
calculate a candidate transmission metric based on an unequal transmit power allocation among the plurality of stations, the unequal transmit power allocation to correspond to the selected individual transmit power allocations; and
select the individual transmit power allocations based on a comparison of the baseline transmission metric to the candidate transmission metric.

10. An apparatus comprising:
a plurality of transmission buffers to buffer data to be transmitted to a respective plurality of stations to be included in an orthogonal frequency division multiple access (OFDMA) group; and
controller circuitry coupled with the plurality of transmission buffers, the controller circuitry to:
receive buffer reports from the plurality of transmission buffers; and
determine, based on the buffer reports, individual transmit power allocations for the plurality of stations;
determine, based on the individual transmit power allocations, individual modulation and coding schemes (MCSs) for the plurality of stations; and
control components of signal processing circuitry to construct, based on the individual transmit power allocations and MCSs, a multi-user (MU) high-efficiency physical protocol data unit (HE-PPDU) to be transmitted to the plurality of stations.

11. The apparatus of claim 10, further comprising the components of the signal processing circuitry, wherein the components include:
a data stream generator to generate a plurality of data streams based on the individual MCSs for the plurality of stations; and
an orthogonal frequency division multiplexing (OFDM) signal generator coupled with the data stream generator to receive the data streams and to generate the MU HE-PPDU based on the data streams.

12. The apparatus of claim 11, wherein the controller circuitry is further to:
receive feedback information from multi-user beamforming reports; and
select the plurality of stations to be included in the OFDMA group based on the feedback information.

13. The apparatus of claim 12, wherein the controller circuitry is further to:
determine, based on the feedback information, signal-to-noise ratios (SNRs) for resource units; and
determine the individual transmit power allocations based further on the SNRs.

14. The apparatus of claim 11, wherein the controller circuitry is further to:
determine a first transmission metric based on a total transmit power allocation of an access point being equal distributed among the plurality of stations included in the ODFMA group;
determine a second transmission metric based on the total transmit power allocation being distributed among the plurality of stations with the individual transmit power allocations; and
determine the individual transmit power allocations are to be used for the MU HE-PPDU based on a comparison of the first transmission metric to the second transmission metric.

15. The apparatus of claim 14, wherein the first transmission metric is a goodput metric or a throughput metric.

16. An access point having:
application circuitry to generate application data to be transmitted to a plurality of stations;
baseband circuitry coupled with the application circuitry to:
select a subset of the plurality of stations;
generate a multi-user (MU) high-efficiency physical protocol data unit (HE-PPDU) to include data to be transmitted to the subset, wherein, to generate the MU HE-PPDU the baseband circuitry is to determine transmit power allocations for the subset of stations, wherein at least two of the transmit power allocations are unequal; and
a radio front end module to transmit the MU HE-PPDU to the subset of stations.

17. The access point of claim 16, further comprising:
memory to store modulation and coding scheme (MCS) information,
wherein the baseband circuitry is further to:
receive feedback information from multi-user beamforming reports; and
select MCSs for the data to be transmitted to the subset of stations based on the transmit power allocations and the feedback information.

18. The access point of claim 16, wherein the radio front end module includes beamforming circuitry to beamform a downlink transmission that includes the MU HE-PPDU.

19. The access point of claim 16, wherein the baseband circuitry is to determine the transmit power allocations for the subset of stations based on an amount of data in transmission buffers respectively corresponding to the subset of stations.

20. One or more non-transitory, computer-readable media having instructions that, when executed by one or more processors, cause an access point to:
calculate a baseline transmission metric based on an equal transmit power allocation among a plurality of stations of an orthogonal frequency division multiple access (OFDMA) group;
calculate a candidate transmission metric based on an unequal transmit power allocation among the plurality of stations of the OFDMA group;
select the unequal transmit power allocation based on a comparison of the baseline transmission metric to the candidate transmission metric; and
construct a multiuser high-efficiency protocol packet data unit (MU HE-PPDU) for transmission to the plurality of stations using the unequal transmit power allocation.

21. The one or more non-transitory, computer-readable media of claim 20, wherein the instructions, when executed, further cause the access point to:
receive feedback information in one or more multiuser beamforming reports;
determine signal-to-noise ratios (SNRs) based on the feedback information; and
map SNRs to first modulation and coding schemes (MCSs) for the plurality of stations.

22. The one or more non-transitory, computer-readable media of claim 21, wherein the instructions, when executed, further cause the access point to:
calculate the baseline transmission metric based on the first MCSs;
determine second MCSs for the plurality of station based on the unequal transmit power allocation; and
calculate the candidate transmission metric based on the second MCSs.

23. The one or more non-transitory, computer-readable media of claim 20, wherein the candidate transmission metric and the baseline transmission metric are throughput values.

24. The one or more non-transitory, computer-readable media of claim 20, wherein the candidate transmission metric and the baseline transmission metric are goodput values, wherein a goodput value is based on (1−PER)*PHY throughput, wherein PER is a packet error rate corresponding to a first transmit power allocation and MCS and PHY throughput is a physical layer throughput corresponding to the first MCS.
